(19) United States
(12) Patent Application Publication
(10) Pub. No.: US 2011/0168486 A1
(43) Pub. Date: Jul. 14, 2011

(54) FALL-ARRESTING SYSTEM

(76) Inventor: Paul Dobrovolsky, Kennewick, WA (US)

(21) Appl. No.: 13/004,286

(22) Filed: Jan. 11, 2011

Related U.S. Application Data
(60) Provisional application No. 61/294,341, filed on Jan. 12, 2010.

(51) Int. Cl. A62B 35/00; B66B 9/02

(52) U.S. Cl. 182/3; 187/269

(57) ABSTRACT

A worker-lifting unit such as a boom lift or scissors lift may be provided with fall-arresting system for a worker. The fall-arresting system may include a worker-support device enclosed by guard rails and an anchoring point for a fall-arresting harness of the worker. The anchoring point may be positioned on the worker-support device high enough so that, when the worker is in the device, the anchoring point is above the worker's harness. Thus the worker may safely leave the device, when it is in a raised position, while the worker's fall-arresting harness may remain attached to the anchoring point.

### RELATED APPLICATIONS

This application claims the benefit of U.S. Provisional Patent Application No. 61294341, filed on Jan. 12, 2010

### BACKGROUND OF THE INVENTION

The present invention generally relates to fall-arresting equipment for workers and more particularly to a system for positioning a fall-arresting anchor above a work location.

In some maintenance and construction work activities, a worker may need to reach a work position that is high above ground level. In such cases, the worker may reach the work position in a basket of a boom lift or on a platform of a scissors lift. Regulatory safety standards have required that the worker remain with confines of the boom lift basket or lift platform while performing work activity. Some tasks are very difficult to perform while the worker is so confined. For example, a worker may need to reach through safety railing of the basket or platform while holding large tools to perform his or her task.

It may be seen that there is a need for a system for positioning a worker at or near a high work location and allowing the worker to exit the confines of safety railing while safely performing work at the high work location.

### SUMMARY OF THE INVENTION

In one aspect of the present invention, a fall-arresting system for a worker may comprise a worker-lifting unit with a worker-support device enclosed by guard rails and an anchoring point for a fall-arresting harness of the worker. The anchoring point may be positioned on the worker-support device high enough so that, when the worker is in the device, the anchoring point is above the worker's harness.

In another aspect of the present invention, a scissors lift may comprise an elevating platform with a guard rail enclosure, a platform extension attached to the platform, an extendable boom above the platform and configured to move with the platform and an anchoring point for a fall-arresting harness of the worker attached to the boom. The anchoring point may be positioned on the boom high enough so that, when the worker is on the platform, the anchoring point is above the worker's harness. The platform extension and the extendable boom may be configured to permit a worker to exit the guard rail enclosure while maintaining attachment of the fall-arresting harness and the anchoring point.

In still another aspect of the invention, a method by which a worker safely position himself or herself at an elevated work location may comprise the steps of entering a worker-support device of a worker-lifting unit, attaching a lanyard of a fall-arresting harness to an anchoring point of the worker-support device, elevating the worker-support device to a position near the work location, exiting the worker-support device while maintaining attachment of the lanyard to the anchoring point, and moving to the work location

These and other features, aspects and advantages of the present invention will become better understood with reference to the following drawings, description and claims.

### BRIEF DESCRIPTION OF THE DRAWINGS

FIGS. 1 and 2 are perspective views of a fall-arresting system in accordance with an embodiment of the invention; and

FIGS. 3 and 4 are elevation views of an alternate embodiment of a fall-arresting system in accordance with the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention generally provide systems for positioning a worker at or near a high work location and allowing the worker to exit the confines of safety railing while safely performing work at the high work location. More particularly, the invention provides such a system with a fall-arresting anchor positioned above the work location

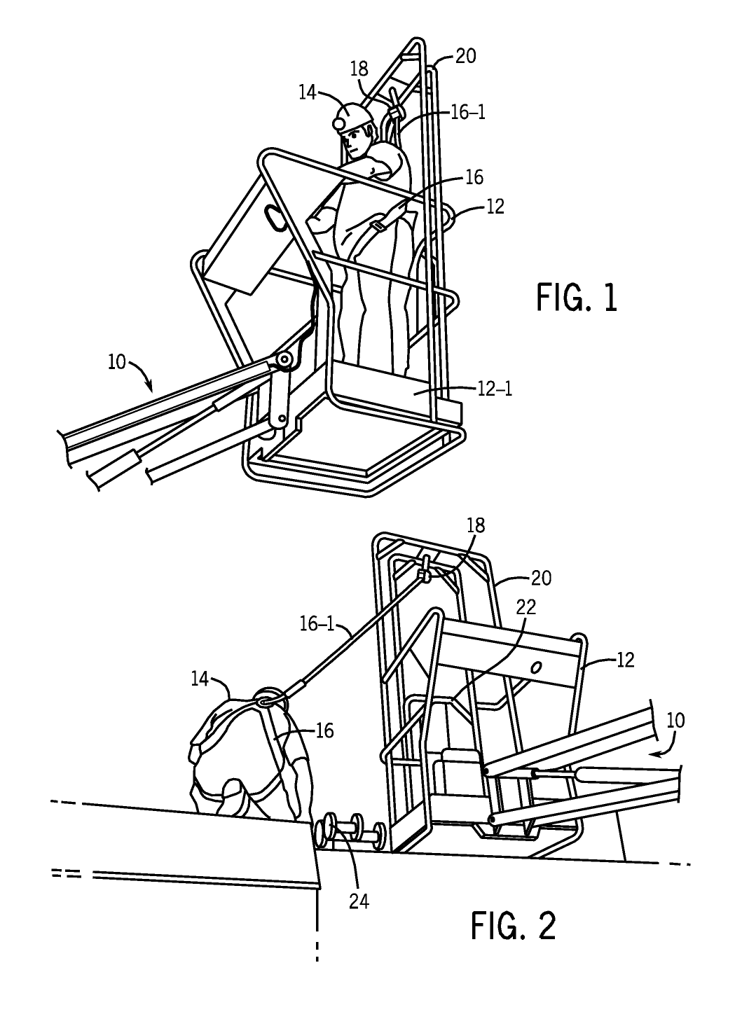

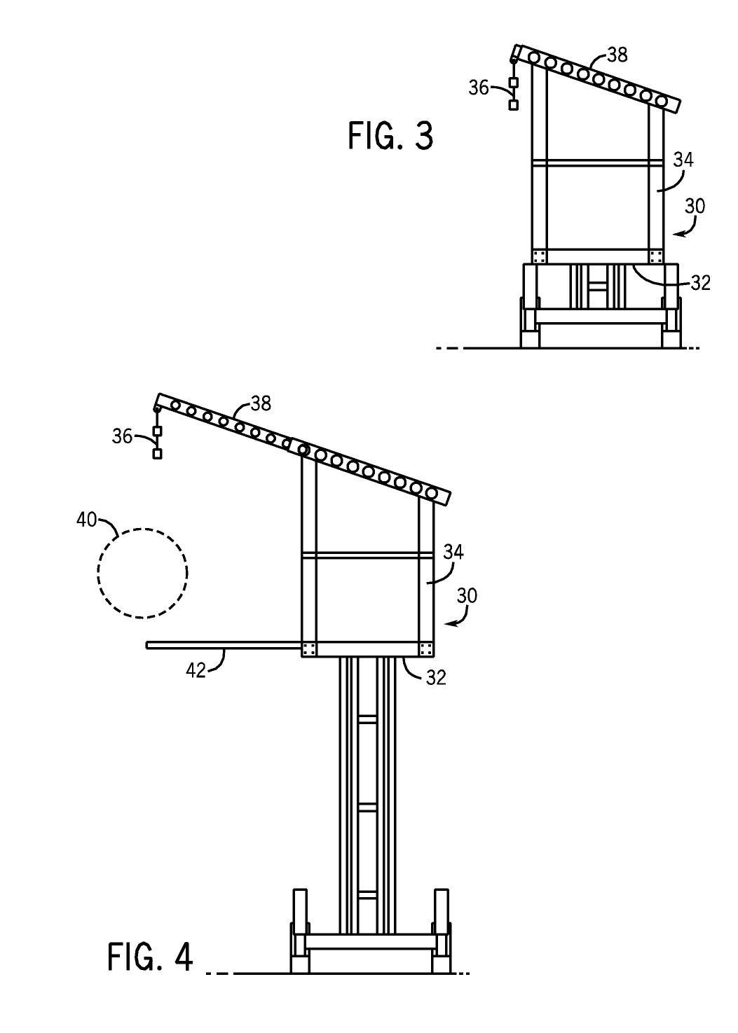

In the Figures, two exemplary worker-lifting units are illustrated. In FIGS. 1 and 2 a boom lift 10 is illustrated and in FIGS. 3 and 4 a scissors lift 30 is illustrated. The present invention may be incorporated into many types of worker-lifting units in addition to the examples described herein.

Referring now to FIG. 1, it may be seen that a worker 14 may stand in a worker-support device or a basket 12 of the boom lift 10 and operate conventional controls to move himself or herself near a work location. The worker 14 may wear a conventional fall-arresting harness 16. A lanyard 16-1 of the harness 16 may be anchored to an anchoring point 18. The anchoring point 18 may be mounted on a frame 20 so that the anchoring point is higher than the harness 16. For example the anchoring point 18 may be positioned about 5 feet to about 7 feet above a floor 12-1 of the basket 12. The frame 20 may be securely attached to the basket 12.

Referring now to FIG. 2, it may be seen that the worker 14 may be at a work location 24 and may be outside of the basket 12. The worker 14 may be in a safe working situation because the fall-arresting harness 16 may secured to the anchoring point 18 by the lanyard 16-1 and the anchoring point 18 is higher than the harness 16. The worker 14 may have arrived at the work location 24 by being elevated by the boom lift 10 to a location near the work location 24. The worker may have then exited the basket 12 through a spring-returned gate 22 to reach the work location 24. Thus, the worker 14 may have been able to conveniently carry tools and/or repair parts to the work location 24 without having to reach out from the basket 12.

Referring now to FIGS. 3 and 4, the scissors lift 30 may be seen with features of the present invention. An elevating worker-support device or platform 32 may be surrounded by a guard rail enclosure 34. An anchoring point 36 may be attached to an extendable boom 38. Upon entering the platform 32, in its lowered position, a worker 14 (see FIGS. 1 and 2) may attach the lanyard 16-1 of his or her fall-arresting harness 16 to the anchoring point 36. After the platform 32 reaches its raised position near a work location 40, a platform extension 42 may be positioned between the platform 32 and the work location 40. The worker 14 may then exit the guard rail enclosure 34 and walk onto the platform extension 42 to reach the work location 40. The boom 38 may extend so that the anchoring point 36 may remain close to the worker 14 and may remain higher than the worker's fall-arresting harness 16. For example the anchoring point 36 may be positioned about 5 feet to about 7 feet above the platform 32. Thus, the worker 14 may conveniently and safely reach the work location 40 even though the work location 40 may be displaced from the platform 32.

It should be understood, of course, that the foregoing relates to exemplary embodiments of the invention and that modifications may be made without departing from the spirit and scope of the invention as set forth in the following claims.

We claim:

1. A fall-arresting system for a worker comprising:
a worker-lifting unit with a worker-support device enclosed by guard rails; and
an anchoring point for a fall-arresting harness of the worker,
the anchoring point positioned on the worker-support device high enough so that, when the worker is in the device, the anchoring point is above the worker's fall-arresting harness.

2. The fall-arresting system of claim 1 wherein the worker-lifting unit is a boom lift and the worker-support device is a basket of the boom lift.

3. The fall-arresting system of claim 2 wherein the basket has a spring-returned gate.

4. The fall-arresting system of claim 2 wherein the anchoring point is supported on a frame attached to the basket.

5. The fall-arresting system of claim 4 wherein the anchoring point is positioned about 5 feet to about 7 feet above a floor of the basket.

6. The fall-arresting system of claim 1 wherein the worker lifting unit is a scissors lift and the worker-support device is a platform of the scissors lift.

7. The fall-arresting system of claim 6 further comprising an extendable boom on which the anchoring point is mounted.

8. A scissors lift comprising:
an elevating platform with a guard rail enclosure;
a platform extension attached to the platform;
an extendable boom above the platform and configured to move with the platform; and
an anchoring point for a fall-arresting harness of the worker attached to the boom, the anchoring point positioned on the boom high enough so that, when the worker is on the platform, the anchoring point is above the worker's harness,
the platform extension and the extendable boom configured to permit a worker to exit the guard rail enclosure while maintaining attachment of the fall-arresting harness and the anchoring point.

9. A method by which a worker safely positions himself or herself at an elevated work location comprising the steps of:
entering a worker-support device of a worker-lifting unit;
attaching a lanyard of a fall-arresting harness to an anchoring point of the worker-support device;
elevating the worker-support device to a position near the work location;
exiting the worker-support device while maintaining attachment of the lanyard to the anchoring point; and
moving to the work location.

10. The method of claim 9 further comprising the step of:
extending a platform extension between the worker-support device and the work location; and
extending a boom on which the anchoring point is mounted to move the anchoring point to a position near the work location.
